(19) United States
(12) Patent Application Publication
(10) Pub. No.: US 2020/0200274 A1
(43) Pub. Date: Jun. 25, 2020

(54) ROTARY SEAL ASSEMBLY AND ROTARY SEAL FOR HIGH-PRESSURE APPLICATIONS

(71) Applicant: Trelleborg Sealing Solutions Germany GmbH, Stuttgart (DE)

(72) Inventor: Jan Kolodziej, Stuttgart (DE)

(21) Appl. No.: 16/805,609

(22) Filed: Feb. 28, 2020

Related U.S. Application Data
(63) Continuation of application No. PCT/EP2018/071354, filed on Aug. 7, 2018.

(30) Foreign Application Priority Data
Aug. 30, 2017 (DE) 10 2017 215 193.5

(51) Int. Cl. F16J 15/34; F16J 15/3244; F16J 15/3248

(52) U.S. Cl. CPC F16J 15/3448; F16J 15/3248; F16J 15/3244

(57) ABSTRACT

A rotary seal assembly includes a viscoelastically deformable support ring having a high-pressure side first support leg connected by a back portion to a low-pressure side second support leg. The legs laterally delimit an annular groove of the support ring open toward the sealing surface retaining a sealing ring. A rubber-elastically deformable pre-loading element between the seal retaining structure and the support ring pre-loads the sealing ring against the sealing surface via the support ring. A pressure activation of the pre-loading element by an operating pressure prevailing on the high-pressure side, the pre-loading element, which is supported on a support surface of one of the two machine parts, is deformed in the pre-loading direction proportionally to the operating pressure such that the support ring is moved toward the sealing surface with the low-pressure-side support leg thereof and is moved away from the sealing surface with the high-pressure-side support leg thereof.

### CROSS-REFERENCE TO RELATED APPLICATIONS

This continuation application claims priority to PCT/EP2018/071354 filed on Aug. 7, 2018 which has published as WO 2019/042720 A1 and also the German application number 10 2017 215 193.5 filed on Aug. 30, 2017, the entire contents of which are fully incorporated herein with these references.

### DESCRIPTION

### Field of the Invention

The invention relates to a rotary seal assembly for high-pressure applications.

### Background of the Invention

Rotary seal assemblies are found in a multiplicity of technical applications and have a first and a second machine part, which are rotatable relative to each other at a distance from each other about an axis of rotation, while forming a sealing gap. One of the two machine parts can be, for example, a (drive) shaft, and the other one can be a housing, on which the shaft is supported. At least one rotary seal is arranged between the two machine parts, by means of which a high-pressure area is sealed off from a low-pressure area of the sealing gap, for example, the ambient atmosphere. The rotary seal is arranged in a retained manner on a seal retaining structure of the one machine part and, according to one design, has a pre-loading ring, a sealing ring, and a support ring for the sealing ring. The sealing ring abuts against the sealing surface of the respective other machine part in a dynamically sealing manner.

The rotary seal of such rotary seal assemblies is subject to enormous mechanical and thermal stress in high-pressure applications, such as in pumps, compressors, or rotary unions. For this reason, adequate lubrication and cooling of the rotary seal must be ensured during operation and excessive sealing pressure of the sealing ring against the sealing surface must be prevented. In addition, design measures must be taken to avoid an undesired extrusion of the sealing element into the sealing gap. Otherwise, the rotary seal may fail prematurely.

### SUMMARY OF THE INVENTION

It is, therefore, the object of the invention to provide a rotary seal assembly and a rotary seal for high-pressure applications which have an improved service life and which can also be provided in a simple and cost-effective manner.

The problem according to the invention is solved by a rotary seal assembly according to claim 1. The rotary seal according to the invention is specified in claim 15. Further developments of the invention are specified in the dependent claims and in the description.

In the rotary seal assembly according to the invention, the rotary seal comprises a support ring which is made of a viscoelastically deformable material and has a first support leg arranged on the high-pressure side and a second support leg arranged at a distance from the first support leg on the low-pressure side. The two support legs are connected to each other by a back portion. The two support legs laterally delimit an annular groove of the support ring, which annular groove is open toward the sealing surface. A sealing ring is held in a retained manner in the annular groove of the support ring. The support ring has greater rigidity than the sealing ring. In this case, the material of the support ring can particularly have a larger modulus or elastic modulus than the material of the sealing ring.

The support ring thus overlaps the sealing ring on three sides. As a result, the sealing ring is arranged in the pre-loading direction and in the direction of the sealing gap and firmly held in position in a retained manner relative to the support ring or essentially firmly held in position in a retained manner on the support ring. If the rotary seal is designed as a radial shaft seal, the support ring then overlaps the sealing ring in a direction radial to the axis of rotation and additionally on both sides in the axial direction. If the rotary seal is designed as an axial shaft seal, the support ring overlaps the sealing ring on only one side in a direction axial to the axis of rotation and on both sides in the radial direction.

The sealing ring abuts (with a dynamic sealing section) against the sealing surface of the respective other machine part in a dynamically sealing manner. A rubber-elastically deformable pre-loading element is arranged between the machine part, having the seal retaining structure, and the back portion of the support ring, by means of which the sealing ring is pre-loaded via the support ring in the direction of the sealing surface.

In the non-pressurized operating state of the rotary seal, the two support legs of the support ring are, according to the invention, spaced apart from the sealing surface. In the non-pressurized state of the rotary seal, the support legs therefore have no contact with the sealing surface, so that undesired friction between the support ring and the sealing surface of the one machine part is prevented. As a result, sufficient lubrication of the contact surface area between the sealing ring and the sealing surface can also be ensured with a fluid arranged on the high-pressure side.

The rotary seal can be pressure-activated via the pre-loading element by means of an operating pressure prevailing on the high-pressure side H. In the case of a pressure activation of the pre-loading element, the pre-loading element, which is supported on a support surface of one of the two machine parts, is deformed in the pre-loading direction of the pre-loading element proportionally to the operating pressure in such a way that the support ring is moved with its low-pressure-side support leg toward the sealing surface, and is moved away with its high-pressure-side support leg from the sealing surface against the pre-loading direction due to a high-pressure-side load relief of the support ring by the pre-loading element. In the case of the rotary seal assembly according to the invention, the pressure activation of the pre-loading element thus leads overall to a reverse deformation of the high-pressure-side edge section of the support ring and the low-pressure-side edge section of the support ring. In other words, the sealing ring is subjected to a moment and is deformed in itself due to the deformation of the pre-loading element. As a result, the sealing gap is increasingly narrowed by the low-pressure-side support leg of the support ring as the operating pressure rises. An undesired extrusion of the sealing ring into the sealing gap can thus be counteracted reliably and adequately. In the present case, “pressure-proportional” refers to a disproportional, proportional, and also an overproportional ratio of the movement of the support ring and the pressure increase of the operating pressure. Overall, the sealing pressure of the sealing ring against the sealing surface, which is essential for the sealing capacity of the rotary seal, as well as the extrusion protection for the sealing ring required for high-pressure applications are controlled on the basis of the prevailing operating pressure or a pressure difference applied between the high-pressure side and the low-pressure side of the rotary seal assembly. A leakage of the rotary seal can thus be reliably prevented even with (higher-frequency) pressure vibrations. If the operating pressure prevailing on the high-pressure side drops, the rotary seal can automatically deform back toward its non-pressurized initial state due to the elastic resilience inherent in the material of the individual sealing components.

According to the invention, the rotary seal can be designed to be (dynamically) sealing in a direction radial or axial to the axis of rotation. In the former case, the sealing ring can be designed to be sealing on the outside or the inside in the radial direction.

According to a preferred embodiment of the invention, the support leg of the support ring arranged on the low-pressure side contacts the sealing surface when a predetermined maximum value of the operating pressure is reached or exceeded. For example, the maximum operating pressure can be 450 bar. As a result, an extrusion of the sealing ring into the sealing gap can be reliably counteracted even in case of maximum pressurization of the high-pressure side. At the same time, a maximum contact or sealing pressure of the sealing ring against the sealing surface can be predetermined.

According to a preferred embodiment of the invention, the pre-loading ring (pre-loading element) extends over the entire width of the sealing ring in the non-pressurized state of the rotary seal. This allows for a uniform application of force into the support ring and thus a uniform contact surface pressure of the sealing edge of the sealing ring against the sealing surface.

In the non-pressurized state of the rotary seal, the pre-loading ring (pre-loading element) very particularly preferably extends over the entire width or almost over the entire width, i.e., at least 80% of the width, of the support ring and/or of the sealing ring.

The sealing ring is preferably held in a retained manner without play in the annular groove of the support ring. This is advantageous for the response behavior of the rotary seal to pressure changes on the high-pressure side.

In order to prevent tilting of the support ring on the seal retaining structure of the one machine part, at least the support leg of the support ring arranged on the low-pressure side is chamfered on the outer side. If each of the two support legs of the support ring are chamfered on the outer side, it is advantageous for a bidirectionally pressure-activatable use of the rotary seal.

According to the invention, the support ring and/or the sealing ring and/or the pre-loading element can each comprise a plastic material or consist of a plastic material. The components mentioned can thus be designed, for example, as injection-molded parts.

For a particularly simple installation and removal of the rotary seal, it is advantageous if the support ring and the sealing ring are designed jointly as a multi-component injection-molded part. As a result, installation errors can also be counteracted. This design also offers cost advantages.

The annular groove of the support ring can particularly be designed to be trapezoidal. This allows for a simple installation and reliable fastening of the sealing ring within the annular groove of the support ring.

According to a particularly preferred development of the invention, the sealing ring has, at least in sections, a spherically designed dynamic sealing edge or a spherically designed dynamic sealing section. In other words, the sealing edge/the sealing section of the sealing ring is, at least in sections, convexly curved outwardly in the direction of the sealing surface in a direction parallel to the sealing gap. This counteracts premature wear of the sealing ring. In addition, the deformation of the support ring imposed by the pressure-activated pre-loading element can thus be supported. A reliable sealing capacity is also ensured in the case of the translational displacement of the maximum of the sealing or contact surface pressure of the sealing ring against the sealing surface associated with the pressure activation of the pre-loading element.

The sealing ring can have tribostructures to support lubrication of the contact surface area of the sealing ring and the (dynamic) sealing surface. The support ring can also have such tribostructures at the free ends of its support legs, which can support adequate lubrication of the contact surface area between the support ring and the sealing surface, particularly when the aforementioned maximum pressure value of the high-pressure-side operating pressure is reached or exceeded.

The support surface, on which the pre-loading element is supported when pressure is activated, is preferably arranged on, particularly formed by, the machine part having the seal retaining structure. As a result, an undesired co-rotation of the pre-loading element acting as a static secondary sealing element can be prevented in case of a pressure-activated pre-loading element.

The support surface can particularly be a shoulder or a groove flank of the seal retaining structure. The seal retaining structure is particularly preferably designed in the form of a retaining groove of the first machine part. This allows for a simple installation of the rotary seal.

The rotary seal can be preinstalled in a principally known manner in a cartridge made of metal, plastic, or a composite material.

The support ring particularly preferably has a design height which is less than half of the width of the annular groove. The sealing ring particularly preferably has a design height which is less than half of the width of the annular groove. This allows for a particularly compact and thermally advantageous design of the rotary seal.

According to the invention, the pre-loading element can be pressure-activated in a bidirectional manner. In this case, the seal retaining structure of the one machine part is preferably designed as a retaining groove, in which the pre-loading element is arranged with play transversely to the loading direction. The rotary seal can therefore also offer a reliable sealing and self-protection functionality in the event of pressure reversal, i.e., inverted pressure.

In the non-pressurized operating state, the back portion of the support ring, in the case of a radially sealing rotary seal, is preferably designed as a cylindrical lateral surface (which is rotationally symmetrical with respect to the axis of rotation), and in the case of an axially sealing rotary seal, it is designed as a preferably flat, annular surface.

The rotary seal according to the invention is particularly suitable for a high-pressure application and can be provided in a simple and cost-effective manner. In addition, the rotary seal offers improved extrusion protection for the sealing ring and can overall offer an improved service life.

In the following, the invention shall be described in more detail using the embodiments shown in the drawings. For the description of the invention, the depicted embodiments shall merely be of an exemplary nature.

### BRIEF DESCRIPTION OF THE DRAWINGS

In the drawings:

FIG. 1 shows a sectional view of a rotary seal assembly, in the non-pressurized operating state, with two machine parts which are arranged so as to be rotatable relative to each other about an axis of rotation, and a rotary seal, which is designed to dynamically seal on the inside in the radial direction with respect to the axis of rotation, having a sealing ring which is arranged within the annular groove of a support element, wherein the sealing ring is pre-loaded by means of a pre-loading element against the sealing surface of the respective other machine part with the interposition of the support ring, and wherein the pre-loading ring can be pressure-activated in such a way that the support ring is deformed when pressurized in such a way that the sealing pressure of the sealing ring is increased on the low-pressure side and reduced on the high-pressure side;

FIG. 2 shows a sectional view of the rotary seal assembly of FIG. 1 in the pressurized state;

FIG. 3 shows a sectional view of a rotary seal assembly, in the non-pressurized initial position, with two machine parts which are arranged so as to be rotatable relative to each other about an axis of rotation, and with a rotary seal which is designed to dynamically seal in the axial direction with respect to the axis of rotation; and

FIG. 4 shows a sectional view of the rotary seal assembly according to FIG. 3 in the pressurized state.

### DETAILED DESCRIPTION OF THE PREFERRED EMBODIMENTS

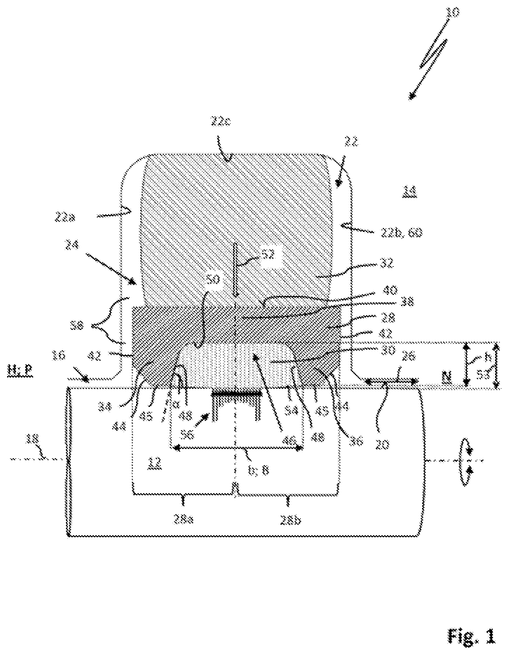

FIG. 1 shows a rotary seal assembly 10 having a first machine part 12 and a second machine part 14 which are arranged at a distance from each other and so as to be rotatable relative to each other about a rotational axis 18, while forming a sealing gap 16. The first machine part 12 can be a shaft, for example, a drive shaft. The second machine part 14 encompasses the first machine part 12 in the radial direction and can be, for example, a housing, on which the shaft is rotatably mounted. The first machine part 12 has a sealing surface 20 on the side of the circumference. The second machine part 14 is provided with a seal retaining structure 22 which, in this case, is designed as an annular retaining groove of the second machine part. The seal retaining structure is delimited by a first flank 22a on the high-pressure side, a second flank 22b arranged on the low-pressure side, and a groove floor 22c. A rotary seal 24 is used to seal the sealing gap 16. The rotary seal 24 seals a high-pressure side H of the sealing gap 16, which can be pressurized with a fluid, in the direction of the longitudinal extension 26 of the sealing gap against a low-pressure side N. FIG. 1 shows the rotary seal 24 in the non-pressurized operating state. The rotary seal 24 is arranged in the retaining groove of the second machine part 14. The rotary seal 24 essentially has three components: A specifically shaped support ring 28, a sealing ring 30, and a pre-loading element 32.

The support ring 28 consists of a viscoelastically deformable material. This can be, for example, a plastic, a plastic composite material, or a metal. With regard to its support function, the support ring 28 is designed to be rigid. According to FIG. 1, the support ring 28 has an essentially U-shaped cross-section with a first support leg 34 arranged on the high-pressure side, and a low-pressure-side second support leg 36 which is arranged, in this case, to be axially spaced apart from said first support leg.

The two support legs 34, 36 are connected to each other via a back portion 38, and both extend away from the back portion 38 in the direction of the sealing surface 20 of the first machine part 12. In the non-pressurized operating state, the back portion 38 has a cylinder jacket-shaped outer side or back surface 40 pointing away from the sealing surface. In the non-pressurized operating state of the rotary seal 24 shown in FIG. 1, the back portion 38 is arranged parallel or essentially parallel to the axis of rotation 18. The support ring 28 also has a side flank 42 which faces the high-pressure side H and one which faces the low-pressure side N. The two side flanks 42 of the support ring 28 can each be designed so as to be flat, i.e., without a surface profiling. At least the flank 42 on the high-pressure side can be provided with one or more grooves, which serve the fluidic connection of the pre-loading element to the high-pressure side. In this case, the side flanks 42 are each connected via a chamfer 44 to the free end surface 45 of the respective support leg 34, 36.

The support ring 28 is provided with an annular groove 46 which is designed to be open toward the sealing surface 20. The annular groove 46 is delimited in the lateral (herein axial) direction by two mutually facing groove flanks 48 of the two support legs 34, 36. The groove flanks 48 are interconnected via a groove base, denoted with 50, of the annular groove 46. According to FIG. 1, the groove flanks 48 can each be arranged at an acute angle α with α<90° to be running obliquely to the sealing surface 20. The annular groove 46 has an (axial) width b which is greater than its (herein radial) depth h. The support ring 28 has a high-pressure-side ring half 28a facing the high-pressure side H and a low-pressure-side ring half 28b facing the low-pressure side N.

The sealing ring 30 is arranged in a retained manner in the annular groove 46 of the support ring 28. By way of example, the sealing ring 30 herein is designed as a radial sealing ring sealing on the inside. The sealing ring 30 consists of a rubber-elastically or viscoelastically deformable material, such as PTFE (polytetrafluoroethylene) or a PTFE compound. The sealing ring has a lower rigidity than the support ring. The material of the sealing ring 30 can have a modulus or elastic modulus which is smaller than the modulus/elastic modulus of the material of the support ring. The sealing ring 30 is covered, continuously on the outer side and over its entire (axial) width B, by the support ring 28 in a direction radial to the axis of rotation, i.e., in the direction of a pre-loading direction, denoted with 52, of the pre-loading element 32. In addition, the sealing ring 30 is laterally overlapped by the support ring 28 on both sides in the direction of the longitudinal extension 26 of the sealing gap 16. The sealing ring 30 engages interlockingly in the axial and radial direction in the annular groove 46 of the support ring 28. The sealing ring 30 thus lies against the groove flanks 48 and the groove base 50 of the annular groove 46 of the support ring 28 over the entire surface or essentially over the entire surface. According to an alternative embodiment, the sealing ring 30 can also be arranged in a retained manner in the annular groove 46 of the support ring 28 with a—preferably only slight—axial play. From a thermal point of view, the sealing ring 30, in the installed state, preferably has a design height 53 which is less than half of the width b of the annular groove 46.

In this case, the sealing ring 30 has a spherically formed dynamic sealing section 54 which lies against the sealing surface 20 of the first machine part 12 in a dynamically sealing manner. In other words, the sealing section 54 is convexly curved toward the sealing surface 20 in the direction of the longitudinal extension 26 of the sealing gap 16. The course of the contact pressure 56 between the sealing section 54 and the sealing surface 20 is shown graphically with arrows. The sealing section 54 extends over the entire (herein axial) width B of the sealing ring 30.

The pre-loading element 32 consists of a rubber-elastically deformable material. It can be a rubber or a suitable elastomer. It must be noted that the material of the pre-loading element 32 allows changes in shape without any or with only an insignificant change in its volume. The material of the pre-loading element 32 is thus isovolumetrically or essentially isovolumetrically deformable.

The pre-loading element 32 is arranged between the support ring 28 and the second machine part 14 having the seal retaining structure 22. The pre-loading element 32 effects a contact pressure 56 of the sealing ring 30, which is essential for the sealing capacity of the rotary seal 24, in the pre-loading direction 52 against the sealing surface 20. The pre-loading element 32 serves as a static secondary seal and, in relation to the axis of rotation 18 it lies in this case in a statically sealing manner in the radial direction, i.e., along the pre-loading direction 52, against the outer side on the groove bottom 22c and against the inner side on the back surface 40 of the back portion 38 of the support ring 28. For this purpose, the pre-loading element 32 has a—herein radial—excess length with respect to the distance between the groove base 50 and the back portion 38 of the support ring 28. Purely exemplary, the pre-loading element 32 herein has an essentially square cross-sectional shape in the installed state, but can also have a different, in particular rectangular, elliptical/oval, or a free-form cross-sectional shape. The pre-loading element 32 is designed as a pre-loading ring.

The pre-loading element 32 is fluidly connected to the high-pressure side H via a free space 58 between the flank 22a arranged on the high-pressure side and the rotary seal 24, and can be pressure-activated by an operating pressure P of a fluid that can be pressurized on the high-pressure side H.

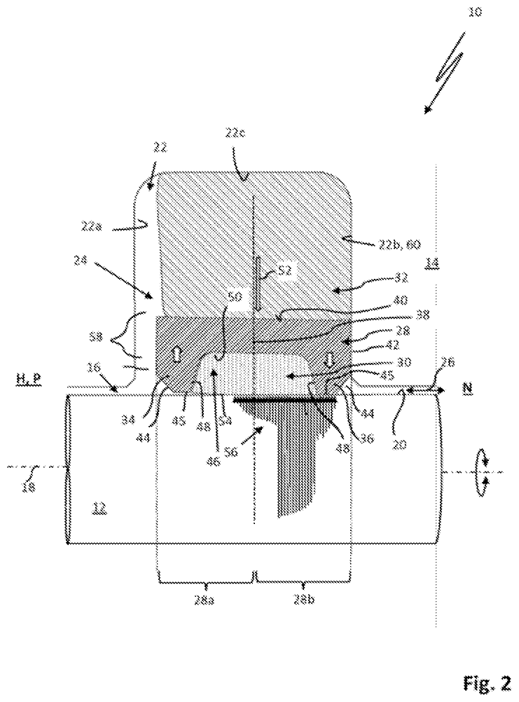

With an increasing operating pressure P, the rotary seal 24 is moved from its initial position shown in FIG. 1 in the direction of the longitudinal extension 26 of the sealing gap, i.e., in the axial direction with respect to the axis of rotation 18, toward the low-pressure side N until the pre-loading element 32 and also the support ring 28 with its side flank 42 lie against the low-pressure-side flank 22b of the seal retaining structure 22 of the second machine part 14. The low-pressure-side flank 22b of the retaining groove serves the pre-loading element 32, and simultaneously the support ring 28, as a stop or support surface 60. The pre-loading element 32 is pressed by the operating pressure P prevailing on the high-pressure side according to FIG. 2 against the low-pressure-side flank 22b of the seal retaining structure 22 and is compressed in the axial direction. As a result, an axially sealing contact of the pre-loading element 32 with the low-pressure-side groove flank 22b is additionally effected. Due to the isovolumetric or essentially isovolumetric deformability of its material, the pre-loading element 32 can only deflect in the pre-loading direction 52 toward the sealing surface 20.

As a result, a bending moment is exerted on the support ring 28. As a result of the bending moment, the support ring 28 in the area of its low-pressure-side ring half 28b is increasingly (elastically) deformed with its support leg 36 in the direction toward the sealing surface 20. In the area of its high-pressure-side edge section, the support ring 28 deforms, due to its partial relief in this area associated with the pressure activation of the pre-loading element, and also due to its flexural rigidity, with the support leg 34 arranged on the high-pressure side in the reverse direction of the pre-loading direction 52 away from the sealing surface 20.

As a result, the support ring 28 moves pressure-proportionally to the fluid pressure/operating pressure P on the high-pressure side H with its low-pressure-side support leg 36 in the radial direction further into the sealing gap 16, thus effecting an increasing extrusion protection for the sealing ring 30. Due to the pressure activation of the pre-loading ring 32, the sealing or contact pressure 56 of the sealing ring 30 against the sealing surface 20 increases simultaneously with increasing operating pressure P. Along with the increasing operating pressure P, the contact pressure 56 of the sealing ring 30 against the sealing surface 20 is spatially moved toward the low-pressure side N. The contact pressure 56 of the sealing ring 30 decreases on the high-pressure side due to the partial relief of the sealing ring 30 on the high-pressure side, which is associated with the deformation of the support ring 28, against the pre-loading direction 52. Lubrication of the sealing ring 30 from the high-pressure side H can thus be improved—pressure-dependently—during the pressurized operation. This is a decisive advantage for the durability of the sealing ring 30.

If the operating pressure P reaches or exceeds a predetermined maximum pressure value Pmax of, for example, 450 bar, the support ring 28 contacts the sealing surface 20 continuously with its low-pressure-side support leg 36, as shown in FIG. 2. The sealing gap 16 is then completely closed toward the low-pressure side N. As a result, an undesired extrusion of the sealing ring 30 into the sealing gap 16, which is directed toward the low-pressure side N, can be reliably prevented. At the same time, the support ring 28 seated on the sealing surface reliably prevents an undesirable mechanical and friction-induced thermal overloading of the sealing ring 30. With regard to the pressure of the sealing ring on the sealing surface, the support ring thus acts as an overpressure limiter.

If the operating pressure P prevailing on the high-pressure side drops below the predetermined maximum pressure value Pmax, the rotary seal 24 deforms due to the elastic resilience of its components in the direction of its initial position shown in FIG. 1.

It must be noted that the low-pressure-side chamfer 44 of the support ring 28 counteracts an excessive mechanical load of the support ring 28 in the contact surface area with the support surface 60 formed by the low-pressure-side flank 22b of the seal retaining structure 22, and a tilting of the support ring 28 with same.

The rotary seal of the rotary seal assembly 10 shown in FIGS. 1 and 2 is also fully functional in an inverted pressure position, i.e., in the case of a pressure gradient directed from the low-pressure side N to the high-pressure side H, in a manner corresponding to the above explanations. When the low-pressure side N is pressurized, the high-pressure-side flank 22a of the seal retaining structure 22 serves in this case as a support surface 60 for the pre-loading element and the support ring. In other words, the rotary seal 24 has a bidirectional functionality.

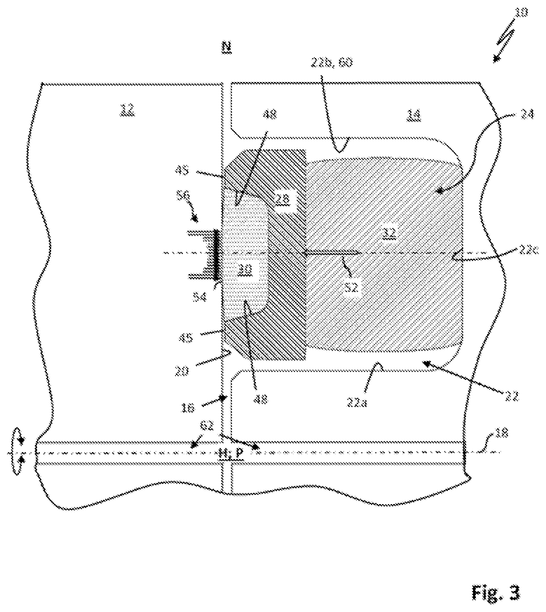

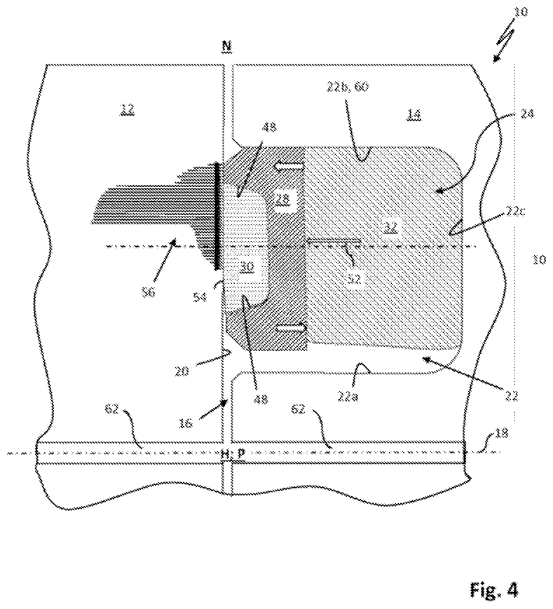

FIGS. 3 and 4 show a rotary seal assembly 10 which essentially differs from the embodiment shown in FIGS. 1 and 2, in that the rotary seal 24 is designed to seal in an axial direction relative to the axis of rotation 18 of the two machine parts 12, 14. According to FIGS. 2 and 3, the rotary seal assembly can be designed as a rotary union for a pressurized fluid. For this purpose, the first and second machine part each have a fluid channel 62, which are fluidly interconnected via the high-pressure side H of the sealing gap 16. Pressurizing the high-pressure side H of the sealing gap 16 with a fluid results in this case in a radial widening of the rotary seal 24, provided that, in the non-pressurized initial state, it does not already lie against the support surface 60 formed by the low-pressure-side groove flank 22b of the retaining groove of the second machine part 14. When it is pressure-activated, the pre-loading element 32 is pressed jointly with the support ring 28 against the support surface 60. Due to the radially directed compression of the pre-loading element 32, it is deformed in the axial direction toward the sealing surface 20 in such a way that the support ring, analogously to the embodiment described above, is deformed toward the sealing surface 20 in the pre-loading direction 52, and is deformed away from the sealing surface 20 against the pre-loading direction 52 on the high-pressure side.

Due to the fact that the pre-loading element 32 of the sealing ring 30 as well as the support ring 28, which stabilizes the sealing ring 30 and serves as extrusion protection, can be pressure-activated, the rotary seal assembly 10 according to the invention is predestined for high-pressure applications in different technical areas.

What is claimed is:

1. A rotary seal assembly, comprising:
a first machine part and a second machine part which are arranged at a distance from each other and so as to be rotatable relative to each other about a rotational axis, while forming a sealing gap, wherein one of the two machine parts has a sealing surface and the respective other machine part has a seal retaining structure;
a rotary seal for sealing a high-pressure side from a low-pressure side of the sealing gap;
a support ring made of a viscoelastically deformable material, which support ring has a first support leg arranged on the high-pressure side and a second support leg arranged on the low-pressure side, wherein the two support legs are connected to each other by a back portion, and the two support legs laterally delimit an annular groove of the support ring, which annular groove is open toward the sealing surface;
a sealing ring arranged in a retained manner in the annular groove of the support ring and engaging interlockingly in the axial and radial direction in the annular groove of the support ring, wherein the sealing ring has a spherically designed dynamic sealing section which abuts against the sealing surface in a dynamically sealing manner, wherein the sealing ring has a lower rigidity than the support ring; and
a rubber-elastically deformable pre-loading element arranged between the seal retaining structure of the one machine part and the support ring in order to pre-load the sealing ring against the sealing surface via the support ring in a pre-loading direction oriented orthogonally to the sealing surface, wherein the material of the pre-loading element is isovolumetrically deformable;
wherein the two support legs of the support ring are each arranged at a distance from the sealing surface in the non-pressurized operating state of the rotary seal, and wherein, in the case of a pressure activation of the pre-loading element by an operating pressure prevailing on the high-pressure side, the pre-loading element, which is supported on a support surface of one of the two machine parts, is deformed proportionally to the operating pressure wherein the support ring is moved toward the sealing surface with the low-pressure-side support leg thereof and is moved away from the sealing surface with the high-pressure-side support leg thereof, until the support ring contacts the sealing surface continuously with its low-pressure-side support leg when a maximum operating pressure is reached or exceeded.

2. The rotary seal assembly according to claim 1, wherein the pre-loading ring in the non-pressurized state of the rotary seal extends over the entire width or almost over the entire width of the sealing ring.

3. The rotary seal assembly according to claim 1, wherein the pre-loading ring in the non-pressurized state of the rotary seal extends over the entire width or almost over the entire width of the support ring.

4. The rotary seal assembly according to claim 1, wherein the sealing ring is retained without play in the annular groove of the support ring.

5. The rotary seal assembly according to claim 1, wherein at least one of the two support legs of the support ring are chamfered on the outer side.

6. The rotary seal assembly according to claim 1, wherein the support ring and/or the sealing ring and/or the pre-loading element comprises a plastic material or consists of a plastic material.

7. The rotary seal assembly according claim 1, wherein the support ring and the sealing ring are designed jointly as a multi-component injection-molded part.

8. The rotary seal assembly according to claim 1, wherein the support surface is arranged on and formed by the machine part having the seal retaining structure.

9. The rotary seal assembly according to claim 1, wherein the support surface is a shoulder or a flank of the seal retaining structure.

10. The rotary seal assembly according to claim 1, wherein the sealing ring has a design height which is less than half of the width of the annular groove.

11. The rotary seal assembly according to claim 1, wherein the pre-loading element can be pressure-activated in a bidirectional manner.

12. The rotary seal assembly according to claim 1, wherein a back surface of the back portion of the support ring in the non-pressurized operating state is a cylindrical lateral surface in the case of a rotary seal designed as a radial seal, and in the case of an axially sealing rotary seal it is an annular surface.

13. The rotary seal assembly according to claim 1, wherein both of the two support legs of the support ring are chamfered on the outer side.
